(19) United States
(12) Patent Application Publication
(10) Pub. No.: US 2012/0004876 A1
(43) Pub. Date: Jan. 5, 2012

(54) Portable System for Auto Var Testing

(76) Inventors: James E. Hart, Englewood, FL (US); Harry Bailey, Venice, FL (US)

(21) Appl. No.: 13/173,106

(22) Filed: Jun. 30, 2011

Related U.S. Application Data
(60) Provisional application No. 61/360,133, filed on Jun. 30, 2010.

(51) Int. Cl. G06F 19/00

(52) U.S. Cl. 702/65

(57) ABSTRACT

A portable package of testing equipment that enables real-time analysis in order to determine the correct amount of capacitance required to add to a motor to achieve optimal performance and power factor correction is provided; the system admits to the monitoring of key power quality measurements such as harmonics while capacitance is temporarily added to the system. A controller automatically calculates the amount of additional capacitance required to reach the desired power factor and then applies the calculated amount to the motor.

### CROSS REFERENCE TO RELATED APPLICATIONS

The present application claims the benefit of prior U.S. Provisional Application No. 61/360,133, filed Jun. 30, 2010.

### FIELD OF THE INVENTION

The present invention relates generally to methods and means for testing electrical equipment, and in a particular though non-limiting embodiment to portable methods and means of determining the optimal static capacitance of a VAR generator, and for evaluating harmonic characteristics associated therewith.

### BACKGROUND OF THE INVENTION

Applying power factor corrections to the motor of an electric power system is already known as an effective and economical way to increase the energy efficiency of the system.

Typically, determining the amount of correction required is accomplished through formulas using average motor size data which yields less than accurate results. An alternative method is accomplished through use of a power meter and formulas that yield accurate sizing results, but do not consider the consequences of the harmonics within the system.

The few testers that are portable have so far been limited to relatively unsophisticated devices employing hand-toggled switches and the like, which render the system less reliable and less safe than switching devices found in larger, fully-automated capacitor banks more commonly found.

Nonetheless, the optimal static capacitance of a motor utilized in a electric power generating system still needs to be determined in order to maximize efficiency and to ensure the correct capacitance level is not exceeded, and those of skill in the art are only beginning to appreciate the importance of evaluating the harmonics associated with such systems for purposes of improving overall efficiency and performance.

As of yet, however, no reliable, portable means have existed for facilitating real-time optimization analysis of power factor corrections and associated capacitance loads, and for evaluating the harmonics associated within an electronic power system.

### SUMMARY OF THE INVENTION

A portable equipment testing system is provided, wherein the system includes at least a capacitor bank having a plurality of capacitors disposed in parallel, and a controller disposed in electronic communication with both the capacitors and an associated logic control system, wherein the logic control system is used to temporarily add capacitance to an associated electrical system during testing.

### DETAILED DESCRIPTION OF SEVERAL EXAMPLE EMBODIMENTS

In order to overcome the deficiencies of the prior art, the instant inventors have reduced to practice a portable package of testing equipment that enables real-time analysis in order to determine the correct amount of capacitance required to add to a motor to achieve optimal performance and power factor correction.

The system also allows monitoring of various power quality measurements such as harmonics while the capacitance is temporarily added to the system. The system is robust and safely constructed, and uses state of the art capacitor switching contactors rather than hand-toggled switches to advance through the testing protocol.

In one example embodiment, the testing equipment is similar to an automatic stepped capacitor bank comprising a plurality of capacitors disposed in parallel, and a controller disposed in electronic communication with a logic control system that automatically adds the correct amount of capacitance to the electrical system.

In another example embodiment, satisfactory optimization is deemed achieved when a predetermined performance characteristic metric has been met (e.g., when the system appears to be performing within a specified percentage of maximum efficiency as modeled by the manufacturer).

In yet another embodiment, satisfactory optimization is deemed achieved when a discretionary efficiency performance criteria is determined by an operator of the system.

In either case, by adding capacitance to the system, precise direct measurements will reveal the most effective power factor correction required at the motor, and the corollary effects of adding capacitance can be measured and evaluated.

An example method of use of the system comprises disposing a motor in an electric power system in electronic communication with a compact, portable capacitance device equipped with a controller of some type, e.g., a computerized controller, or a controller controlled by a logic system or processor, etc. The controller automatically calculates the amount of additional capacitance required to reach the desired power factor and then applies the calculated amount to the motor.

In one embodiment, the system comprises an integrated revenue grade meter and approximately 2 megabytes of data-logging used to record a measuring event with a real-time clock that allows for time stamping of all the data in the instrument. Those of skill in the art will appreciate that other, previously known backup systems, redundancies and safety features typically associated with such sub-systems can also be employed, either separately or together, in order to increase the safety and reliability of the testing system.

According to a presently contemplated best mode of practicing the invention, the system described herein has the capability to either manually or automatically apply a correct level of capacitance to an inductive load in order to satisfy a predetermined power factor correction. As presently reduced to practice, an example embodiment of the system can accommodate both 208 Vac and 480 Vac 3 φ applications.

In one embodiment, the testing system further comprises a plurality of interconnected modules. A first module comprises a controller (for example, a 12-step controller), a plurality of capacitor banks (for example, five capacitor banks), and a power meter equipped with a digital, metered or graphical computer interface. A second module comprises five additional capacitor banks, thereby bringing the total number of capacitor banks in the system to ten.

In the example system described above, each capacitor bank has a different value, and is connected in parallel. The first module has approximately 27.5 kVAr available for 480 Vac applications, and approximately 5.2 kVAr available for 208 Vac applications. The second module has approximately 25 kVAr available for 480 Vac applications, and approximately 4.7 kVAr available for 208 Vac applications. Together, the modules total approximately 52.5 kVAr for 480 Vac applications, and approximately 9.9 kVAr available for 208 Vac applications.

A third module (or more) can also be added to the system so long as the operator is using fewer than the maximum number of steps available. For example, a third module can be added if desired so long as an operator is using only ten of twelve available steps.

Despite the specificity of the examples cited herein, those of ordinary skill in the art will appreciate that these values are relatively arbitrary and described for illustrative purposes only, and can therefore be adjusted either up or down to fit the needs of any given application.

In still other embodiments, the system further comprises an on-board power meter equipped with Ethernet capability. The meter is preferably multifunctional and includes at minimum the ability to take instantaneous “snapshots” of the system power quality as well as log associated test results for as long as necessary for an operator to complete an assessment.

The claimed system's sophisticated controllers, meters and communicative software make the portable tester a valuable and novel means of analyzing the overall power quality of an electric power system's motor. Other functionality, such as the ability to evaluate harmonics associated with the system (either with or without added capacitance) further serves to differentiate the system from the prior art.

The foregoing specification is provided for illustrative purposes only and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from the spirit or scope thereof.

1. A portable equipment testing system, said system comprising:
a capacitor bank, said capacitor bank further comprising a plurality of capacitors disposed in parallel; and
a controller disposed in electronic communication with both the capacitors and an associated logic control system, wherein said logic control system is used to temporarily add capacitance to an associated electrical system during testing.

2. The system of claim 1, wherein said system admits to real-time analysis in order to determine the amount of additional capacitance required to achieve optimal electrical system performance.

3. The system of claim 1, wherein said system further admits to the monitoring of one or more key power quality measurements while additional capacitance is temporarily added to the system.

4. The system of claim 3, wherein said key power quality measurements include harmonics measurements.

5. The system of claim 1, wherein satisfactory optimization of the associated electrical system is deemed achieved when one or more predetermined performance characteristic metrics have been satisfied.

6. The system of claim 5, wherein satisfactory optimization of the associated electrical system is deemed achieved when the electrical system being tested performs within a predetermined percentage of its predetermined maximum efficiency.

7. The system of claim 5, wherein satisfactory optimization of the electrical system being tested is deemed achieved when a discretionary efficiency performance criteria is determined by an operator of the system.

8. The system of claim 1, wherein when additional capacitance is added to the system, direct capacitance measurements are used to determine the most effective power factor correction required.

9. The system of claim 1, further comprising an integrated revenue grade meter and data-logging memory used to record a measuring event using a real-time clock.

10. The system of claim 9, wherein said real-time clock is used to facilitate electronic time-stamping of all data stored in the system.

11. The system of claim 1, wherein said system admits to either manual or automatic application of additional capacitance to an inductive load in order to satisfy a predetermined power factor correction.

12. The system of claim 1, wherein sais system further comprises a plurality of interconnected testing modules.

13. The system of claim 12, wherein a first testing module comprises a controller; a plurality of capacitor banks; and a power meter equipped with one or more of a digital, metered or graphical user interface.

14. The system of claim 13, wherein said system further comprises a second module having additional capacitor banks, thereby increasing the total number of capacitor banks in the system.

15. The system of claim 14, wherein said system further comprises a third module having additional capacitor banks, thereby increasing the total number of capacitor banks in the system.

16. The system of claim 1, wherein said system further comprises an on-board power meter.

17. The system of claim 16, wherein said on-board power meter is equipped with Ethernet capability.

18. The system of claim 16, wherein said on-board power meter is multifunctional, and includes at minimum the ability to take instantaneous measurements of the system power quality.

19. The system of claim 18, wherein said multifunctional power meter also includes a means for logging associated test results for as long as necessary for an operator to complete an assessment of the electrical system being tested.

20. A method of using a portable equipment testing system, said method comprising:
disposing a motor in an electric power system in electronic communication with a portable capacitance device equipped with a controller; and
using said controller to automatically calculate an amount of additional capacitance required to reach a desired power factor and then apply the calculated amount to an associated electrical system.
